(19) United States
(12) Patent Application Publication
(10) Pub. No.: US 2018/0061220 A1
(43) Pub. Date: Mar. 1, 2018

(54) SYSTEMS AND METHODS FOR SUPPRESSING UNWANTED HOME AUTOMATION NOTIFICATIONS

(71) Applicant: Echostar Technologies L.L.C., Englewood, CO (US)

(72) Inventor: Gregory Greene, Littleton, CO (US)

(21) Appl. No.: 15/246,259

(22) Filed: Aug. 24, 2016

(51) Int. Cl. G08B 29/18; G08B 13/196; G06K 9/00

(52) U.S. Cl. CPC G08B 29/185; G08B 13/19695; H04W 4/12; G06K 9/00362; G06K 9/00288; G06K 9/00771

(57) ABSTRACT

Various arrangements for handling a home automation notification are presented. A home automation event may be determined to have occurred based on wireless data received from a home automation device. An authorized user may be determined to be present at a home at which the home automation host system is installed. Transmission of the home automation notification indicative of the home automation event may be suppressed to various authorized users based on the authorized user being determined to be present at the home. The home automation event may be logged such that an indication of the home automation event and a timestamp are stored locally by the home automation host system.

### CROSS-REFERENCES TO RELATED APPLICATIONS

This Application is related to U.S. patent application Ser. No. 15/246,079, entitled “Trusted User Identification and Management for Home Automation Systems” filed on Aug. 24, 2016, having an attorney docket number of P2016-06-13 (1015163), the entire disclosure of which is hereby incorporated by reference for all purposes.

### BACKGROUND

Home automation systems allow users to receive all sorts of information related to their home. For instance, when motion is detected at a home, a home automation system may send notifications to a user informing him of the motion. Such information can be useful to the user, such as if he was not expecting any motion or visitors while he was away from home. However, frequently, such a notification may be triggered by another authorized person or animal. For instance, a user's child may trigger motion detectors daily when returning from school. Such an abundance of “false positives” (that is, notifications about occurrences that a user is not interested in) can annoy a user and result in information fatigue. Such a situation can result in a user ignoring notifications and, potentially, missing useful notifications.

### SUMMARY

Various arrangements are presented for handling a home automation notification including methods and systems. A home automation event may be determined to have occurred based on wireless data received from a home automation device. An authorized user of a plurality of authorized users may be determined to be present at a home at which the home automation host system is installed. Transmission of the home automation notification indicative of the home automation event may be suppressed to at least a subset of the plurality of authorized users based on the at least one authorized user being determined to be present at the home. The home automation event may be logged such that an indication of the home automation event and a timestamp are stored locally by the home automation host system.

Embodiments of such systems and methods may include one or more of the following features: Location information for each home automation device of a plurality of home automation devices may be stored. The location information for each home automation device of the plurality of home automation devices may indicate a specific location at the home at which the home automation device is installed. The home automation device can be part of the plurality of home automation devices. A distance may be determined between the authorized user and the home automation device at which the home automation event occurred. A threshold distance may be compared with the distance between the authorized user and the home automation device at which the home automation event occurred, wherein suppressing transmission of the home automation notification indicative of the home automation event to at least the subset of the plurality of authorized users is further based on the distance between the authorized user and the home automation device at which the home automation event occurred being less than the threshold distance. The home automation notification may be transmitted to the authorized user located at the home based on the distance between the authorized user and the home automation device at which the home automation event occurred being less than the threshold distance. Determining the authorized user is present at the home may be performed based on facial recognition from a video feed captured by a home automation video device. A video feed captured by the home automation device may be analyzed to determine a pet triggered the home automation event, wherein the home automation event is a motion detection home automation event. In response to analyzing the video feed captured by the home automation device and determining the pet triggered the motion detection home automation event, ceasing recording the video feed. Determining the authorized user is present at the home may be performed using a location of a mobile device linked with a user account of the authorized user. Less than a threshold amount of time may be determined to have elapsed between the authorized user of the plurality of authorized users being present at the home at which the home automation host system is installed and the home automation event occurring.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a home automation system.

FIG. 2 illustrates an embodiment of a home automation host that manages distribution of home automation notifications.

FIG. 3 illustrates an embodiment of a home at which various home automation sensors are installed with each home automation sensor being associated with a particular location at the home.

FIG. 4 illustrates an embodiment of a method for transmitting or suppressing home automation notifications.

FIG. 5 illustrates an embodiment of a method for managing home automation events and notifications when a pet is present in the home.

FIG. 6 illustrates an embodiment of a method for managing home automation notifications based on individual home automation sensor locations.

FIG. 7 illustrates an embodiment of a method for configuring individual home automation sensor locations.

FIG. 8 illustrates a home automation computerized processing system.

### DETAILED DESCRIPTION

Notifications of home automation events can be useful to a user when the user is provided with information that the user was not expecting. A user being notified of everyday, mundane events can result in the user getting information fatigue and the user ignoring some or all of his received notifications. As an example, in a conventional arrangement, if a user has a home automation video camera installed to monitor his living room, motion may be detected dozens of times per day due to the user's pet moving within the room. Further, other persons, such as children or a spouse, may open doors or windows, trigger motion detection, or perform some other event at a home that typically results in a home automation notification being sent to a user. Ideally, notifications may be provided to the user only for home automation events that the user was not expecting or that the user will find useful.

Specifically, notifications provided to a user may be suppressed by a home automation system in response to determinations related to the locations of authorized users. If an authorized user is determined to be present at a home or has been determined to be present at the home within a predefined period of time, notifications to one or more users remote from the home may be suppressed. It may be possible for a user to configure a home automation system to manage distribution of notifications based on user-defined rules that govern how home automation notifications are to be handled based on the locations of particular registered or authorized users.

In some embodiments, a finer level of location analysis may be performed. In such embodiments, the individual location of home automation sensors within a home may be stored by a home automation system. Even if an authorized user is present at a home, a home automation notification from a home automation sensor may be triggered by an event that the authorized user (or some other user who may be remote from the home) should be notified about. For example, a basement window opening while the authorized user is upstairs may be worth of a notification. By comparing a distance between a user and the location of a home automation sensor that detects a home automation event, it can be determined whether a home automation notification should be sent and to which users.

It should be understood that while this document refers to “home” automation devices and “homes,” it should be understood that the principles detailed herein are applicable to wireless sensors and devices that can be installed at locations other than homes, such as businesses, office buildings, warehouses, etc.

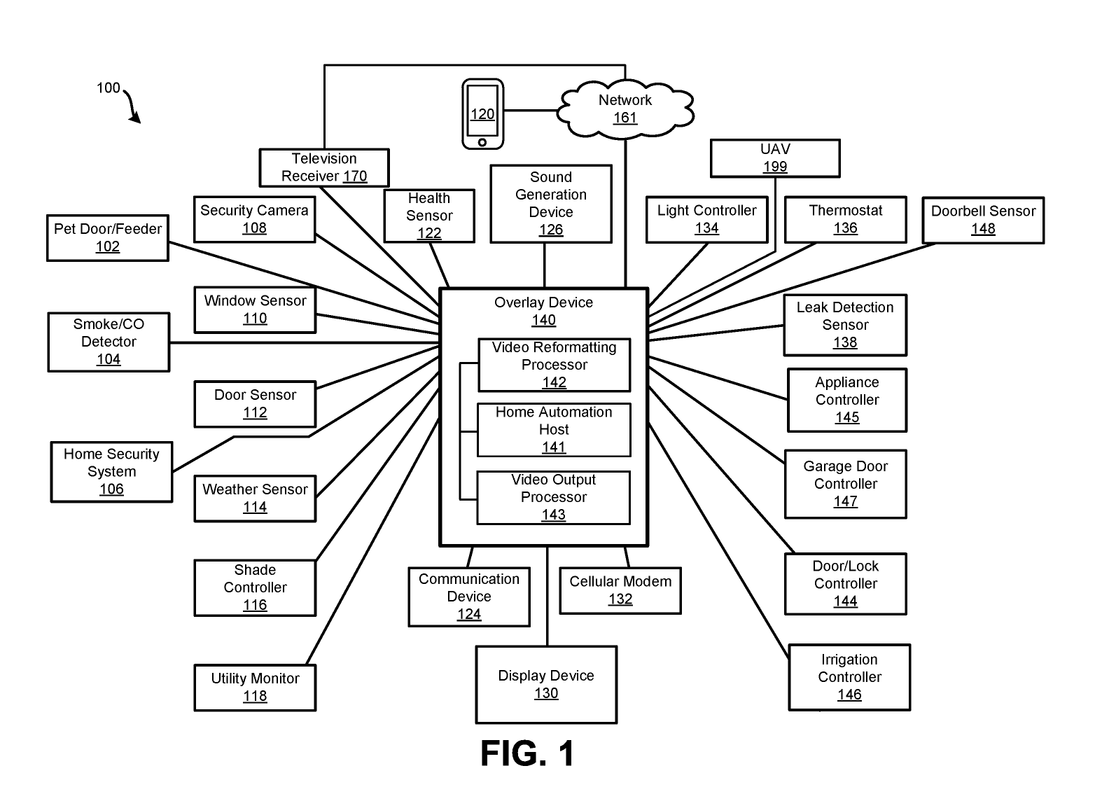

Detail regarding the above various embodiments of methods and systems that can be used for suppressing home automation notifications or routing home automation notifications and other possible embodiments are detailed in relation to the Figures. FIG. 1 illustrates an embodiment of a home automation system that can generate and transmit home automation notifications to local and remote authorized users. FIG. 1 illustrates an embodiment of a home automation system 100 hosted by an overlay device 140. As such, in home automation system 100, overlay device 140 functions as the home automation host system. Overlay device 140 refers to a device that can be connected with a separate display device 130, such that information regarding the home automation system is presented by display device 130. In some embodiments, overlay device 140 receives data from a separate device, such as television receiver 170, and overlays home automation data and user interfaces over television signals (e.g., television programming) output by television receiver 170. Television receiver 170 may be configured to receive television programming from a satellite-based television service provider; in other embodiments, other forms of television service provider networks may be used, such as an IP-based network (e.g., fiber network), a cable based network, a wireless broadcast-based network, etc.

In some embodiments, overlay device 140 may be coupled between television receiver 170, which may be in the form of a set top box (STB), and display device 130, which may be a television. In such embodiments, television receiver 170 may receive, decode, descramble, decrypt, store, and/or output television programming. Television receiver 170 may output a signal, such as in the form of an HDMI signal. Rather than be directly input to display device 130, the output of television receiver 170 may be input to overlay device 140. Overlay device 140 may receive the video and/or audio output from television receiver 170. Overlay device 140 may reformat and/or add additional information to the video and/or audio signal received from television receiver 170. The modified video and/or audio signal may be output to display device 130 for presentation. In some embodiments, overlay device 140 has an HDMI input and an HDMI output, with the HDMI output being connected to display device 130.

In FIG. 1, overlay device 140 includes video reformatting processor 142, home automation host 141, and video output processor 143. While video reformatting processor 142 and video output processor 143 may be implemented using separate processors, it should be understood that the functionality of these blocks may be performed by a single processor or processing device. Video reformatting processor 142 may receive video from an external source, such as television receiver 170. This video may be reformatted, such as by being changed to a different resolution, and an output video signal is formatted such that the video is only output for display in a particular portion of a display device's screen. Home automation host 141 may output home automation information, such as information related to any of the connected home automation devices of FIG. 1. Video output processor 143 may combine video reformatted by video reformatting processor 142 and home automation data from home automation host 141 for output to display device 130.

In the illustrated embodiment of FIG. 1, overlay device 140 serves as a home automation host system. In other embodiments, it should be understood that television receiver 170 may serve as the home automation host system. Therefore, in other embodiments, functionality attributed to overlay device 140 may instead be fully or partially implemented by television receiver 170. In still other embodiments, a different device, such as a dedicated computerized device, or another device illustrated as part of home automation system 100, can serve as the home automation host system.

Overlay device 140 may be configured to communicate with multiple home automation devices. The devices with which overlay device 140 communicates may use different communication standards, including both wireless and wired communication standards. For instance, one or more devices may use a low-power wireless network communication protocol, such as ZigBee® while one or more other devices communicate using Z-Wave®. Other forms of local wireless communication may be used by devices and overlay device 140. For instance, overlay device 140 and one or more devices may be configured to communicate using a wireless local area network, which may use a communication protocol such as IEEE 802.11.

Using overlay device 140 to present automation information via display device 130 may have additional benefits. For instance, multiple devices may provide input video to overlay device 140. For instance, television receiver 170 may provide television programming to overlay device 140, a DVD/Blu-Ray® player may provide stored content to overlay device 140, and a separate internet-TV device may stream other programming to overlay device 140. Regardless of the source of the video/audio, overlay device 140 may output video and/or audio that has been modified to include home automation information and output to display device 130. As such, in such embodiments, regardless of the source of video/audio, overlay device 140 may modify the audio/video to include home automation information and, possibly, solicit for user input. For instance, in some embodiments, overlay device 140 may have four video inputs (e.g., four HDMI inputs) and a single video output (e.g., an HDMI output). In other embodiments, such overlay functionality may be part of television receiver 170. As such, a separate device, such as a Blu-ray® player, may be connected with a video input of television receiver 170, thus allowing television receiver 170 to overlay home automation information when content from the Blu-Ray® player is being output to display device 130.

Regardless of whether television receiver 170 is itself configured to provide home automation functionality and output home automation input for display via display device 130 or such home automation functionality is provided via overlay device 140, home automation information may be presented by display device 130 while television programming is also being presented by display device 130. For instance, home automation information may be overlaid or may replace a portion of television programming (e.g., broadcast content, stored content, on-demand content, etc.) presented via display device 130.

In some embodiments, a separate device may be connected with overlay device 140 to enable communication with home automation devices. For instance, communication device 124 may be in communication with overlay device 140. Communication device 124 may be in the form of a dongle. Communication device 124 may be configured to allow for Zigbee®, Z-Wave®, and/or other forms of (low-power) wireless or wired communication. The communication device may connect with overlay device 140 via a USB port or via some other type of (wired) communication port. Communication device 124 may be powered by the overlay device (or television receiver, if the television receiver is serving as the home automation host system) or may be separately coupled with a power source. In some embodiments, overlay device 140 may be enabled to communicate with a local wireless network and may use communication device 124 in order to communicate with devices that use a ZigBee® communication protocol, Z-Wave® communication protocol, and/or some other home wireless communication protocols.

Communication device 124 may also serve to allow additional components to be connected with overlay device 140 or television receiver 170. For instance, communication device 124 may include additional audio/video inputs (e.g., HDMI), a component, and/or a composite input to allow for additional devices (e.g., Blu-ray players) to be connected with television receiver 170 and/or overlay device 140. Such connection may allow video from such additional devices to be overlaid with home automation information. Whether home automation information is overlaid onto video may be triggered based on a user's press of a remote control button.

Regardless of whether overlay device 140 uses communication device 124 to communicate with home automation devices, overlay device 140 may be configured to output home automation information for presentation to a user via display device 130, which may be a television, monitor, or other form of device capable of presenting visual information. Such information may be presented simultaneously with television programming received by television receiver 170. Television receiver 170 may also, at a given time, output television programming that may be augmented or replaced by home automation information by overlay device 140. The user may be able to provide input to television receiver 170 and/or overlay device 140 to control the home automation system hosted by either television receiver 170 or by overlay device 140, as detailed below.

Television receiver 170 or overlay device 140 may be configured to communicate with one or more wireless devices, such as (wireless) mobile device 120. Mobile device 120 may represent a tablet computer, cellular phone (e.g., smartphone), laptop computer, remote computer, or some other device through which a user may desire to control home automation settings and view home automation information. Such a mobile device also need not be wireless, such as a desktop computer. Television receiver 170, communication device 124, or overlay device 140 may communicate directly with mobile device 120, or may use a local wireless network, such as network 161. Mobile device 120 may be remotely located and not connected with a same local wireless network. Via the Internet, television receiver 170 or overlay device 140 may be configured to transmit a notification and/or other information to mobile device 120 regarding home automation information. For instance, in some embodiments, a third-party notification server system, such as the notification server system operated by Apple®, may be used to send push notifications to mobile device 120.

In some embodiments, a location of mobile device 120 may be monitored. A user may be able to define which home automation functions are controlled based on a position of mobile device 120. For example, as detailed within this document, whether a notification is sent may be dependent on a location of a mobile device relative to a home automation sensor for which the notification is pertinent. Other functions could include opening and/or closing a garage door, adjusting temperature settings, turning on and/or off lights, opening and/or closing shades, etc. Such location-based control may also take into account the detection of motion via one or more motion sensors that are integrated into other home automation devices and/or stand-alone motion sensors in communication with television receiver 170.

In some embodiments, little to no setup of network 161 may be necessary to permit television receiver 170 to stream data out to the Internet. For instance, television receiver 170 and network 161 may be configured, via a service such as SLING or other video streaming service, to allow for video to be streamed from television receiver 170 to devices accessible via the Internet. Such streaming capabilities may be “piggybacked” to allow for home automation data to be streamed to devices accessible via the Internet. For example, U.S. patent application Ser. Number 12/645,870, filed on Dec. 23, 2009, entitled “Systems and Methods for Remotely Controlling a Media Server via a Network,” which is hereby incorporated by reference, describes one such system for allowing remote access and control of a local device. U.S. Pat. No. 8,171,148, filed Apr. 17, 2009, entitled “Systems and Methods for Establishing Connections Between Devices Communicating Over a Network,” which is hereby incorporated by reference, describes a system for establishing connection between devices over a network.

Mobile device 120 may serve as an input device for television receiver 170 and/or overlay device 140. For instance, mobile device 120 may be a tablet computer that allows text to be typed by a user and provided to television receiver 170. Such an arrangement may be useful for text messaging, group chat sessions, or any other form of text-based communication. Other types of input may be received for the television receiver from a tablet computer or other device as shown in the attached screenshots, such as lighting commands, security alarm settings and door lock commands. While mobile device 120 may be used as the input device for typing text, television receiver 170 may output for display text to display device 130. As another example, if a user needs to provide a location (such as Global Positioning System (GPS) coordinates) to a home automation system, mobile device 120 may be brought to the physical location associated with a waypoint to log the associated coordinates.

In some embodiments, a cellular modem 132 may be connected with either overlay device 140 or television receiver 170. Cellular modem 132 may be useful if a local wireless network is not available. For instance, cellular modem 132 may permit access to the Internet and/or communication with a television service provider. Communication with a television service provider may also occur via a local wireless or wired network connected with the Internet. In some embodiments, information for home automation purposes may be transmitted by a television service provider system to television receiver 170 or overlay device 140 via the television service provider's distribution network, which may include the use of satellites.

Various home automation (sensor) devices may be in communication with television receiver 170 or overlay device 140. Some or all of such home automation devices may function as part of a low-power wireless network mesh network to allow for communication between home automation host 141 and such devices. Such home automation devices may use disparate communication protocols. Such home automation devices may communicate with television receiver 170 directly or via communication device 124. Such home automation devices may be controlled by a user and/or have a status viewed by a user via display device 130 and/or mobile device 120. Home automation devices may include: smoke/carbon monoxide (CO) detector 104, home security system 106, pet door/feeder 102, security camera 108, window sensor 110, irrigation controller 146, weather sensor 114, shade controller 116, utility monitor 118, heath sensor 122, sound generation device 126 (which can refer to the sound generation devices of FIGS. 1-5), light controller 134, thermostat 136, leak detection sensor 138, overlay device 140, appliance controller 145, garage door controller 147, and doorbell sensor 148.

Leak detection sensor 138 may detect the presence of water or the flow of water through a pipe. The presence of water or the excessive flowing of water through the pipe may trigger a message to be transmitted to the home automation host system. Appliance controller 145 may be able to provide status messages about one or more appliances and/or control the functionality of one or more appliances. Garage door controller 147 may provide a status on the position of a garage door (open or closed) and/or may be able to control opening and closing of the garage door. Irrigation controller 146 may be able to provide a status of an irrigation system (on, off, current zone being watered) and may be able to control the irrigation system. Shade controller 116 may be able to provide a status as to the current position of a shade and may be able to control the position of the shade. Window sensor 110 may be able to provide a status as to the current position of a window (open or shut) and may be able to control the position of the window. Sound generation device 126 may refer to the sound generation devices detailed in relation to FIGS. 1-5 and can allow for sound to be output into the ambient environment of the sound generation device. Light controller 134 may be able to control whether a light is on or off and may be able to provide a status of the light. Pet door/feeder 102 may allow for home automation host 141 to control whether the pet door is locked or unlocked and dispense food. Smoke/CO detector 104 may be combined detector device or separate devices that can detect the presence of smoke and/or CO and provide such a status to home automation host 141. Home security system 106 may be enabled and disabled via home automation host 141 and may provide status information to home automation host 141 (e.g., movement detected, door ajar, glass break, etc.). Weather sensor 114 may provide weather data to home automation host 141. Utility monitor 118 may provide information on the use of utilities (e.g., power, gas, oil, water) to home automation host 141.

Door sensor 112 and lock controller 144 may be incorporated into a single device, such as a door lock and sensor unit, and may allow for a door's position (e.g., open or closed) to be determined and for a lock's state to be determined and changed. Door sensor 112 may transmit data to television receiver 170 or overlay device 140 that indicates the status of a door. Such status may indicate open or closed. When a status change occurs, the user may be notified as such via mobile device 120 or display device 130. Further, a user may be able to view a status screen to view the status of one or more door sensors throughout the location. Window sensor 110 and/or door sensor 112 may have integrated glass break sensors to determine if glass has been broken. Lock controller 144 may permit a door to be locked and unlocked and/or monitored by a user via television receiver 170 or overlay device 140. No mechanical or electrical component may need to be integrated separately into a door or door frame to provide such functionality. Such a single device may have a single power source that allows for sensing of the lock position, for sensing of the door position, and for engagement and disengagement of the lock.

UAV 199 can be capable of streaming video and/or audio gathered outside of a home to display device 130 via overlay device 140 (or television receiver 170) and/or streaming such video and/or audio to a remote server via network 161. Via a service provider's server system, the video and/or audio may be streamed to mobile device 120 or any other remote computerized device through which an authorized user is logged in. In some embodiments, video and/or audio from UAV 199 may be retrieved directly by mobile device 120 from overlay device 140.

Additional forms of sensors not illustrated in FIG. 1 may also be incorporated as part of a home automation system. For instance, a mailbox sensor may be attached to a mailbox to determine when mail is present and/or has been picked up. The ability to control one or more showers, baths, and/or faucets from television receiver 170 and/or mobile device 120 may also be possible. Pool and/or hot tub monitors may be incorporated into a home automation system. Such sensors may detect whether or not a pump is running, water temperature, pH level, a splash/whether something has fallen in, etc. Further, various characteristics of the pool and/or hot tub may be controlled via the home automation system. In some embodiments, a vehicle dashcam may upload or otherwise make video/audio available to television receiver 170 or overlay device 140 when within range. For instance, when a vehicle has been parked within range of a local wireless network with which the home automation host is connected, video and/or audio may be transmitted from the dashcam to the television receiver for storage and/or uploading to a remote server.

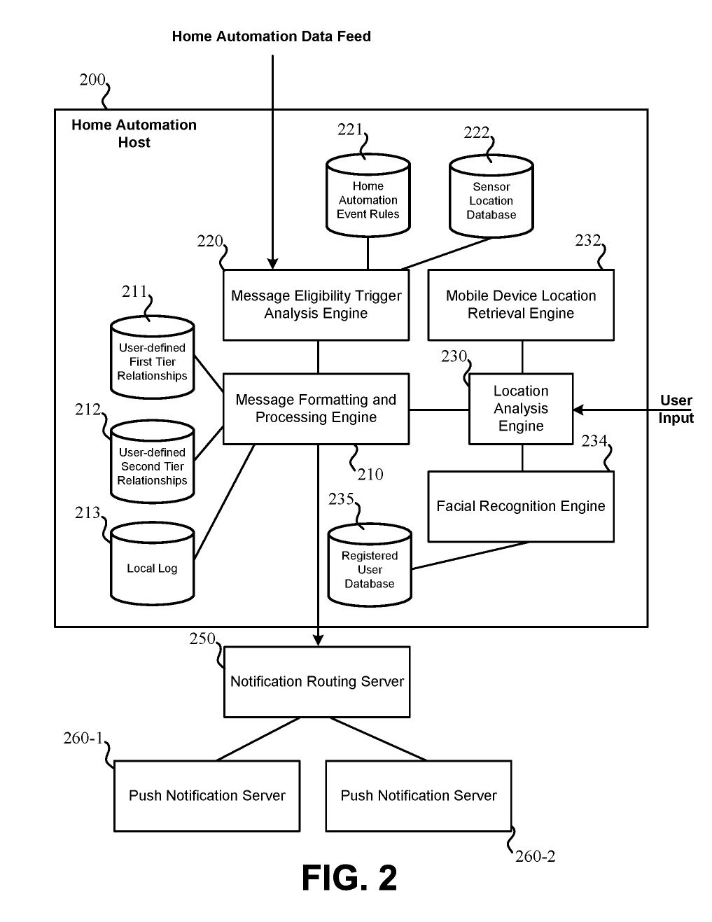

FIG. 2 illustrates an embodiment of a home automation host 200 that manages distribution of home automation notifications. Home automation host 200 can represent home automation host 141 of FIG. 1. As such home automation host 200 may be incorporated as part of an overlay device or television receiver. In other embodiments, home automation host 200 may be incorporated as part of a home automation host system that is not implemented using an overlay device or television receiver. Home automation host 200 may include: message formatting and processing engine 210, user-defined first-tier relationships 211, user-defined second-tier relationships 212, local log 213, message eligibility trigger analysis engine 220, home automation event rules 221, sensor location database 222, location analysis engine 230, mobile device location retrieval engine 232, and facial recognition engine 234. Each of these components may be implemented by an overlay device using one or more processors and one or more non-transitory computer readable mediums. It should be understood that in other embodiments, functionality of such components may be distributed among multiple devices either locally or remotely.

Home automation data may be received by home automation host 200 and may be routed to message eligibility trigger analysis engine 220. Message eligibility trigger analysis engine 220 may determine whether received home automation data is eligible to trigger a notification being sent to one or more registered users. Home automation event rules 221 may represent a database of rules that define particular conditions which may be present in home automation data received as part of the home automation data feed. As an example, a rule stored by home automation event rules 221 may indicate that, if motion is detected by home automation device of an unauthorized person, a home automation event has occurred and a notification is eligible to be transmitted (also referred to as a candidate notification). As another example, home automation event rules 221 may indicate a rule that, if a window is opened, a notification is eligible to be transmitted. Whether or not a notification is actually transmitted after eligibility has been affirmatively determined may be determined by message formatting and processing engine 210. The rules of home automation event rules 221 may be user-defined or divined by a service provider that communicates with home automation host 200.

Sensor location database 222 may define particular locations of home automation sensors. The particular locations of the home automation sensors may be determined on a global basis, such as using GPS coordinates. The particular locations of the home automation sensors may alternatively be defined locally, such as based on a distance and direction from home automation host 200. The specific location of sensors as stored in sensor location database 222 may be defined by user, such as by the user indicating a floor and/or room or location in which the sensors located. For example, a video camera may be labeled by user as “garage entrance.” The particular locations of the home automation sensors may be used in determining whether or not a notification should be transmitted to a registered user.

Message formatting and processing engine 210 may determine whether or not home automation data which is eligible to be provided to a registered user in the form of a notification should or should not be sent. Message formatting and processing engine 210 may take into account various factors in determining whether a home automation notification should be sent and, if so, to whom. Message formatting and processing engine 210 may receive data from location analysis engine 230. Location analysis engine 230 may determine where various authorized or registered users are located in relation to the home at which home automation host 200 is operating. For any given home automation host, multiple users may be authorized or registered.

Location analysis engine 230 may determine the location of various users using data from mobile device location retrieval engine 232 and facial recognition engine 234. Mobile device location retrieval engine 232 may serve to provide location analysis engine 230 with a physical location of where a mobile device associated with a user is located. This location may be provided in the form of GPS coordinates or a simpler geo-fenced indication, such as whether the mobile device is located inside or outside of a geo-fence defined in relation to the home at which home automation host 200 is installed. Mobile device location retrieval engine 232 may determine the location of multiple mobile devices associated with multiple users that are authorized or registered. Facial recognition engine 234 may analyze one or more video feeds from cameras located at the home at which home automation host 200 operates. Facial recognition engine 234 may access registered and authorized user database 235 (which may store an entry for every authorized or registered user) in an attempt to identify whether users are present at the home. Authorized user database 235 may store a link to each authorized user's mobile device and, if facial recognition is to be used, one or more images or models of the user for comparison. If facial recognition engine 234 recognizes an authorized user in a video feed from a camera located at the home within a threshold period of time, it may be assumed that the user is present at the home. Even if the user leaves the field of view of the camera, the user may be assumed to be home for at least a stored and defined period of time based on the authorized user having been facially recognized, such as ten minutes. Location analysis engine 230 may aggregate location data from mobile device location retrieval engine 232 and facial recognition engine 234. If conflicting data is received for a same user, location analysis engine 230 may determine which data is more likely to be trusted. For instance, a user may have forgotten his mobile device in his car, but facial recognition engine 234 may recognize the user entering the home. Location analysis engine 230 may determine, for instance, whether the mobile device has moved more recently or the user has been identified by facial recognition engine 234.

Location analysis engine 230 may further receive user input from multiple registered users. A registered user may, such as via an application being executed by his mobile device, be able to specify whether he is at home or away from home. This information may be used individually or in combination with data from mobile device location retrieval engine 232 and facial recognition engine 234 to determine if a user is truly at the home or is away.

Message formatting and processing engine 210 may receive location data for multiple users from location analysis engine 230. Message formatting and processing engine 210 may determine whether or not to transmit a notification based on user-defined first-tier relationships 211 and user-defined second-tier relationships 212 along with the location data received from location analysis engine 230. User-defined first-tier relationships 211 and user-defined second-tier relationships 212 may define which users are to receive notifications and in what circumstances.

User-defined first-tier relationships 211 may be used to determine how notifications should be distributed when no user is determined to be present at the home. User-defined second-tier relationships 212 may be used to determine how notifications should be distributed if a registered user is present at the home. Table 1 provides an exemplary arrangement for user-defined first tier relationships.

TABLE 1

| | Notification | Trigger | Notification | Feedback |
|---|---|---|---|---|
| User | Device | Data | Type | Requested |
| P. Joseph | Camera | Motion | In App | No |
| P. Joseph | Window | Window | Push | Yes |
| | Sensor | Open | | |
| H. Martinez | Garage Door | Open | Push | Yes |

User-defined first-tier relationships 211 may be specified by a user and may define: a user, a notification device (i.e. the home automation sensor that generates the data that serves as the notification trigger), the trigger data (i.e. the specific data received from the notification device that triggers the notification), the notification type (how the notification should be distributed, such as text message, email, push notification, in application message, etc.), and whether feedback is required to be provided by the user acknowledging the notification.

User-defined second-tier relationships 212 may be used to determine how notifications should be distributed when at least one registered user is determined to be present at the home.

TABLE 2

| Highest Ranking | Threshold | Notify | Notify | Feedback |
|---|---|---|---|---|
| User Home | Distance | User | Other User | Requested |
| P. Joseph | 75 ft. | Yes | No | No |
| W. Pan | 25 ft. | Yes | No | No |
| Older Child | 10 ft. | Yes | Yes - P. Joseph | No |
| Younger Child | — | No | Yes - P. Joseph | Yes |

For user-defined second-tier relationships 212, registered users may be ranked. If at least one registered user is present at the home (e.g., within the home or outside the home within a given distance to account for a user being in the front or back yard), the user-defined second-tier relationship used may be for the highest ranked user. Table 2, as presented, is in descending order from highest to lowest rank for an example family. Therefore, for example, if P. Joseph and Older Child are home, but W. Pan and Younger Child are not, the second-tier relationships would be enforced according to P. Joseph's defined characteristics.

A threshold distance may be defined according to user-defined second-tier relationships 212 for some users. The threshold distance may define whether a notification is sent based on home automation sensor data from a home automation sensor. If the home automation sensor is determined to be at least the threshold distance from the associated user determined to be at the home, the home automation notification is transmitted. “Notify User” indicates whether the user himself or herself should receive the notification. “Notify Other User” indicates whether another user, who may or may not be present at the home, should also receive the notification, and, if so, who that user is. “Feedback Requested” indicates whether the user is requested to respond to the notification. Not indicated for simplicity, user-defined second-tier relationships 212 may also include user definable fields that specify specific types of notifications, such as “notification devices,” “trigger data,” and “notification type.”

As an example of how user-defined second-tier relationships 212 may be used by message formatting and processing engine 210, using Table 2 as an example, if only the older child and younger child are home and a home automation sensor outputs data that causes message formatting and processing engine 210 to evaluate user-defined second-tier relationships 212, a notification may be transmitted if the older child is more than 10 feet from the home automation sensor that output the data triggering the candidate notification. If the older child is more than ten feet from the home automation sensor that output the triggering data, the older child and P. Joseph may receive a notification indicative of the data sensed by the home automation sensor. As another example, if P. Joseph is home (regardless of whether any other user is home since he is the highest ranked user) and the home automation sensor that triggers a candidate notification is more than seventy-five feet from him, a home automation notification may be sent to him, such as in the form of a push notification to a mobile device registered and linked with him. If another registered user is also detected at the home, for the notification to be eligible to be sent, the home automation sensor from which the data originated may also need to be outside of the threshold distance associated with this other user. For example, if P. Joseph and W. Pan are home, the home automation sensor that generates the home automation data that results in a candidate notification may need to be at least 75 feet away from P. Joseph and at least 25 feet from W. Pan. Some users may not have a threshold distance, such as the younger child. Regardless of the distance from the younger child, the home automation notification may be sent.

Local log 213 may store a log of notifications that have been sent and, possibly, also notifications that were not sent to users, such as due to the threshold distance requirement. Local log 213 may be accessible by a user via a user interface (e.g., output by overlay device 140) and may store information for each notification including: notification device, trigger data, date, time, reason notification was or was not sent, to whom notification was sent, form in which notification was sent, and home automation data associated with notification (e.g., video footage, audio recording, image, etc.).

Message formatting and processing engine 210, if a notification is to be transmitted following analysis of user-defined first-tier relationships 211 and user-defined second-tier relationships 212, may transmit an indication to notification routing server 250. Notification routing server 250 may be operated by a service provider that provides remote cloud computing services to home automation host 200. Notification routing server 250 may then send the home automation notification via a determined route to the mobile device of the user to be notified. If a push notification is to be sent, notification routing server 250 may transmit a push notification request to a push notification server associated with the operating system or manufacturer of the user's mobile device. For example, push notification server 260-1 may process and distribute push notifications for Apple®/iOS® devices and push notification server 260-2 may process and distribute push notifications for Android® devices. If a form of message other than a push notification is to be sent, notification routing server 250 may route the home automation notification via the appropriate route, such as text, recorded message, in-application message (e.g., only visible when the user opens an associated application on his mobile device and the home automation notification is retrieved).

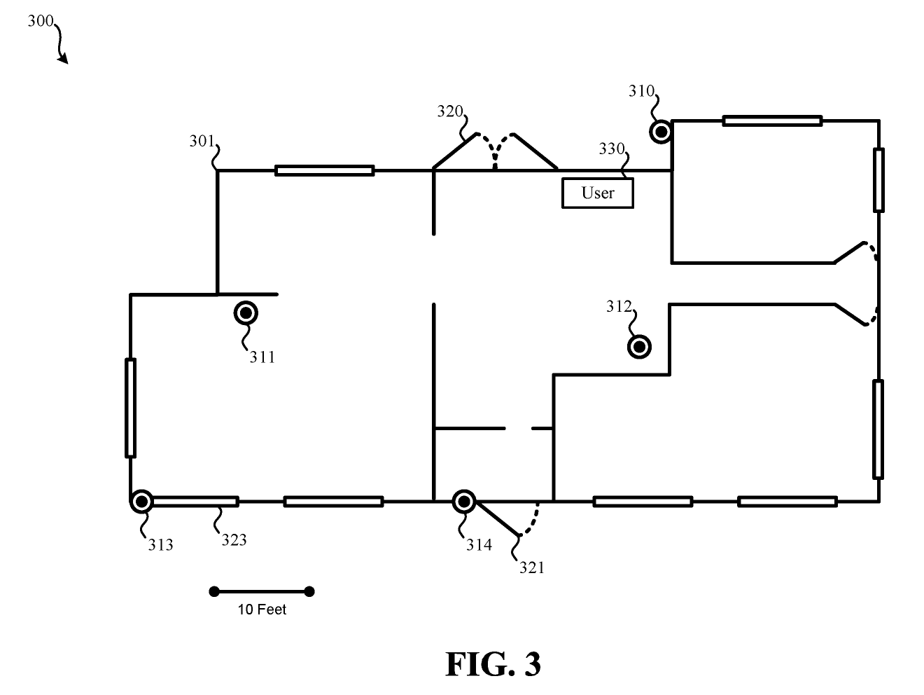

FIG. 3 illustrates an embodiment of a map 300 of a home 301 at which various home automation sensors are installed with each home automation sensor being associated with a particular location at home 301. At the home, home automation sensors 310, 311, 312, 313, and 314 are present. These home automation sensors may be various types. For example, home automation sensor 310 may be a video camera that monitors the vicinity of doors 320, home automation sensor 311 may be a light, home automation sensor 312 may be an audio sensor, home automation sensor 313 may be a window sensor that detects when window 323 is opened or shut, and home automation sensor 314 may be a door sensor that monitors when door 321 is opened or shut.

User 330 represents an exemplary registered user that is present at the home. In this example, only user 330 is home. As an example, assume user 330 is W. Pan from Table 2, thus having a threshold distance of 25 feet. If a candidate home automation notification is based on data from home automation sensor 310, the notification would not be sent since the highest ranked user that is home has a threshold distance that is greater than a distance between home automation sensor 310 and user 330. If a candidate home automation notification is based on data from home automation sensor 313, the notification would be sent since the highest ranked user that is home has a threshold distance that is less than a distance between home automation sensor 313 and user 330.

In some embodiments, in addition to using distance, whether the registered user is inside or outside may affect whether a home automation notification is sent. Home automation sensors may be classified as indoor or outdoor by a user at the home automation host; for example, home automation sensor 310 may be classified as outdoor while home automation sensor 311 is classified as indoor. If a user is outdoors, the user may receive home automation notifications attributed to indoor-classified home automation sensors regardless of the user's threshold distance; if a user is indoors, the use may receive home automation notifications attributed to outdoor-classified home automation sensors regardless of the user's threshold distance. Similar classifications may be set by a user for floor (e.g., basement, first floor, second floor), outdoor region (e.g., backyard, front yard, etc.), or some other category which a user may find more useful than basing home automation notifications on a raw distance measurement.

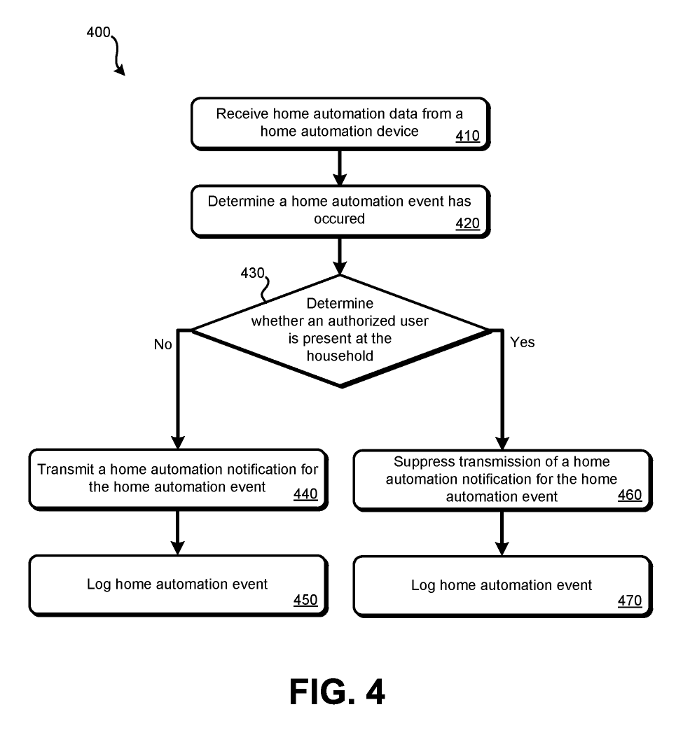

Various methods may be used using the systems and arrangements of FIGS. 1-3. FIG. 4 illustrates an embodiment of a method 400 for transmitting or suppressing home automation notifications. Method 400 may be performed using a home automation host, such as home automation host 200, which can be incorporated as part of overlay device 140, television receiver 170, or some other form of home automation host system which can reside at a home or, possibly, remotely such as in the form of a cloud-based platform.

At block 410, home automation data may be received from a home automation device at a home. The home automation data is received by the home automation host, which can physically reside at the home and may be in wireless communication with the home automation device. At block 420, based on the received home automation data, the home automation host may determine that a home automation event has occurred that results in a candidate notification. Referring to FIG. 2, message eligibility trigger analysis engine 220 may determine, based on the received home automation data and home automation event rules 221, whether the home automation data is a candidate for being sent in a notification. As an example, if the home automation data includes a video feed and motion is detected within the video feed, if home automation event rules 221 indicate that a notification is, under at least some circumstances, to be sent based on motion being detected, message formatting and processing engine 210 may evaluate to whom, if anyone, a notification indicative of the motion should be sent.

At block 430, a determination of whether a registered user is present at the home may be made. This determination may be made by the home automation host or some other component that is either located locally at the home or may be part of a remote, cloud-computing system (e.g., a server system hosted by a service provider). The determination made at block 430 may be based wholly or partly on: facial recognition performed using one or more video data streams gathered from home automation devices at the home, mobile device locations (e.g., GPS), and/or user input (e.g., a user specifying whether the user is present at the home or away from the home). The determination of block 430 may be performed for each registered or authorized user. Referring to FIG. 2, the home automation host may maintain a database of registered users. Additionally or alternatively, such a registered user database may be maintained by a remote server system hosted by a service provider.

If block 430 is determined in the negative, meaning no authorized user is present at the home from a group of multiple authorized users, a notification may be transmitted based on a first set of relationships (e.g., user-defined first-tier relationships 211 of FIG. 2) if the home automation data matches a predefined relationship that defines when a user desires a notification to be sent at block 440. This predefined relationship may specify the type of home automation data that triggers a notification, to whom the notification should be sent, and the form the notification should be sent, such as exemplified in Table 1. At block 450, a log entry of the home automation event may be stored. This entry may include an indication of the notification sent, whether it was received, the home automation data that triggered the notification, who received the notification, whether feedback was received in response to the notification, etc.

If block 430 is determined in the positive, meaning an authorized user is present at the home from a group of multiple authorized users, a notification may be suppressed such that a notification that would be sent if no user was at home is not sent at block 460. Such suppression may be performed in accordance with a second set of relationships (e.g., user-defined second-tier relationships of FIG. 2). Such a second set of relationships can result in a different notification being sent (e.g., to a different authorized user) and the notification that would be sent in accordance with the first set of relationships being suppressed. Alternatively, both notifications may be sent. At block 470, a log entry of the home automation event may be stored. This entry may include an indication of the home automation event that did or did not result in a notification being sent, if so, whether it was received, the home automation data related to the home automation event, etc.

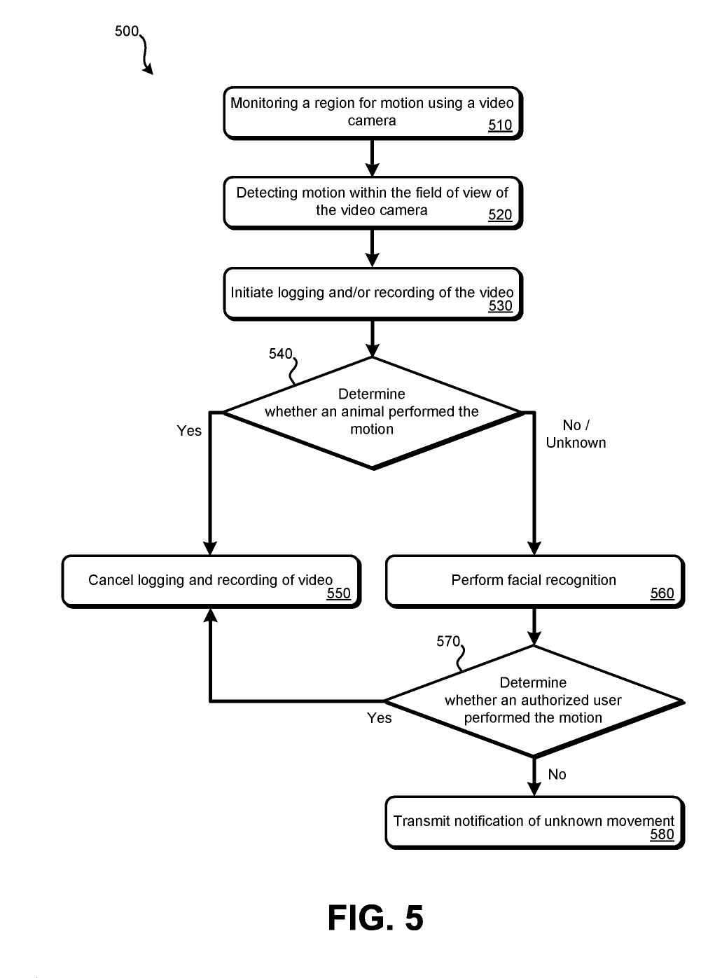

FIG. 5 illustrates an embodiment of a method 500 for managing home automation events and notifications when a pet (or other non-human animal) is present in or near the home. Method 500 may be performed using a home automation host, such as home automation host 200, which can be incorporated as part of overlay device 140, television receiver 170, or some other form of home automation host system which can reside at a home or, possibly, remotely such as in the form of a cloud-based platform. Method 500 may be performed in conjunction with other methods detailed herein—as such filtering for a pet can be performed, for example, in conjunction with method 400 or method 600.

At block 510, a region may be monitored using a video camera for motion. Common examples include living areas and entry ways. At block 520, motion within the camera's field of view may be detected. The motion may be detected by the home automation host based on a video feed streamed to the home automation host from the camera. Alternatively, the motion may be detected by the camera itself or a remote video service that monitors for motion as part of a cloud-based service.

At block 530, the video stream may begin to be recorded. Recording may initiate due to the motion detected at block 520. In some embodiments, a video feed is always recorded. In such embodiments, at block 530, a time at which the motion began being detected may be logged. When motion is detected, no notification may be immediately sent to a user for at least a predefined period of time stored by the home automation host. During this predefined period of time, the home automation host can be attempting to determine if the motion is attributed to an animal or some other non-human source. This log entry may serve as a bookmark such that a user can easily jump to the portion of the video recording that has been attributed with including motion. At block 540, a determination may be made as to whether a (non-human) animal is to be attributed for the motion. A pet database may be stored that links visual characteristics with types of pets (e.g., a large dog, small dog, cat, bird, etc.) If there are no matches, then it is determined that the motion of the unidentified object (which is likely a person) deserves further analysis.

At block 550, if an animal was attributed for the motion at block 540, the recording of the video may be canceled and the portion of the video recorded since block 530 was performed may be deleted. If in the embodiment a constant stream of video is recorded regardless of motion, the log entry may be deleted such that no reference is present to the animal recorded video. In some embodiments, the recording and/or log is maintained, but no notification is transmitted at block 550.

At block 560, if it is determined that the motion is not attributed to an animal, facial recognition may be attempted to be performed to recognize the human. A camera may have a form of facial recognition software locally installed to find and highlight faces within the field-of-view of the lens and auto-focus on those faces. The camera may identify possible faces in the camera's field-of-view that has detected motion. If one or more faces are identified, these faces can be compared with a stored database of pictures of trusted people. If the facial recognition reveals that the person is an authorized or registered user at block 570, block 550 may be performed to eliminate log entries and/or a recording of the video. In such an instance, no notification may be sent since the user is determined to be authorized.

If at block 570, no authorized user is determined as being attributed for the motion, a notification may be sent in accordance with the rules and relationships as detailed in FIG. 2 at block 580. The notification may be a push notification and may link a user to a video clip that includes the unknown motion. Further, if a threshold amount of time elapses since block 520, a notification may be sent regardless of whether blocks 540-570 have been performed. That is, a maximum amount of time may be permitted for the video camera, home automation host, and/or cloud-based video monitoring system to assess whether an animal caused the motion and if an authorized user can be attributed for the motion. If determinations cannot accurately be made within the threshold amount of time, a notification may be sent to a user, such as in accordance with the first-tier and second-tier relationships of FIG. 2.

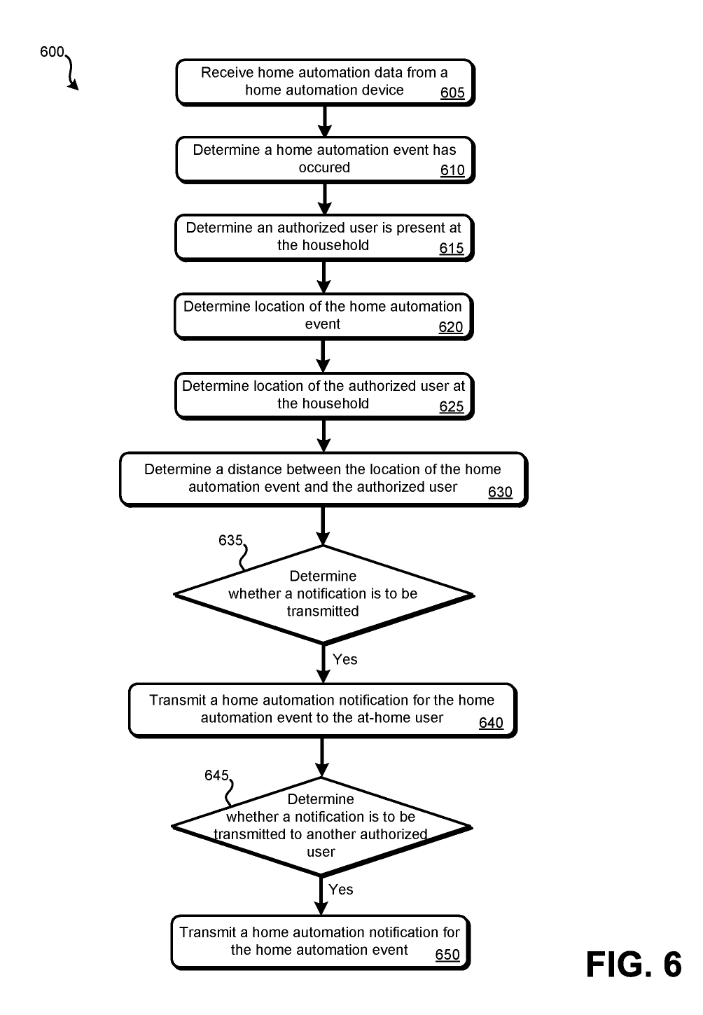

FIG. 6 illustrates an embodiment of a method 600 for managing home automation notifications based on individual home automation sensor locations. Method 600 may be performed using a home automation host, such as home automation host 200, which can be incorporated as part of overlay device 140, television receiver 170, or some other form of home automation host system which can reside at a home or, possibly, remotely such as in the form of a cloud-based platform.

At block 605, home automation data may be received by a home automation host from a home automation device. Some home automation devices or sensors may stream data to the home automation host to be analyzed, such as a video camera. In other devices, only data that has been determined by the home automation device to be worthy of transmission may be transmitted. For example, a door sensor may only transmit data when a state change (door opened, door shut) is detected. At block 610, the home automation host may determine that a home automation event has occurred based on the received home automation data. Referring to FIG. 2, message eligibility trigger analysis engine 220, in combination with home automation event rules 221 may be used to determine that a home automation event has occurred and a notification is eligible to be sent.

At block 615, a determination may be made that from a list of multiple authorized or registered users, at least one of those users is present at the household. This determination may be made as detailed in relation to location analysis engine 230 of FIG. 2. As such, information from the location of mobile devices, facial recognition, and user input defining whether the user is home may be used to determining which users are home or away from home.

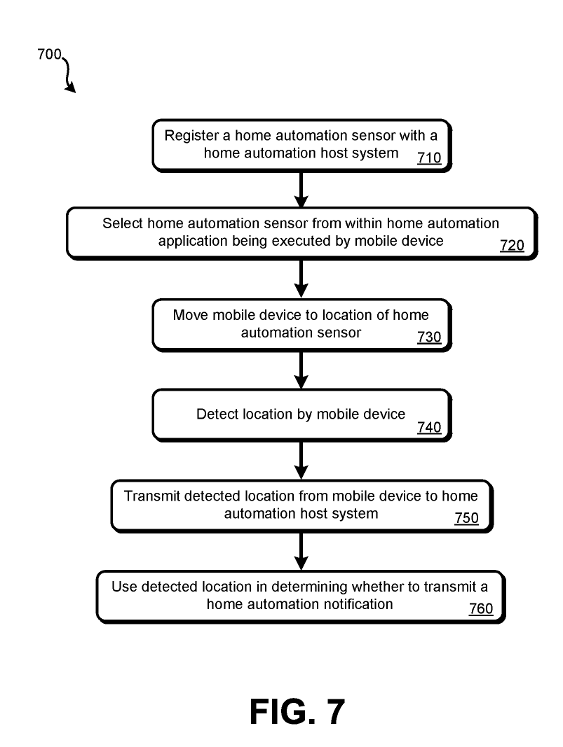

At block 620, a location of the home automation event within (or near) the home may be determined. The location may be based on a predefined location of the home automation sensor. The location of the home automation sensor may be determined in accordance with method 700 of FIG. 7. The home automation host may store a table, database, or other form of data storage arrangement which relates locations with the home automation sensors. In some embodiments, some home automation sensors may have on-board location sensors, such as GPS sensors. In such embodiments, the home automation sensor may transmit its location to the home automation host.

The location of an authorized user within the household may be determined at block 625. If multiple authorized users are present within the household, each of their locations may be determined. The location may be determined using GPS (e.g., based on the user's mobile device), facial recognition, and/or dead reckoning. At block 630, a distance between the home automation event and the authorized user(s) may be determined. At block 635, this distance may be used to determine if a notification is to be transmitted. The location determined at block 630 may be compared with a threshold distance that is defined for all registered users or which is specific to individual users, such as exemplified in Table 2. If the distance is outside of the threshold distance, method 600 may proceed to block 640. Otherwise, no notification may be transmitted and only a log entry may be stored by the home automation host (or, possibly, no log entry).

At block 640, the home automation notification may be transmitted that is indicative of the home automation event. The home automation notification may be sent to the user who is at home, such as in accordance with relationships defined in relation to Table 2. In some embodiments, a notification may not be sent to the user that was determined to be at home, for instance, if only a child is home, the notification may not be worth sending to him. The determination of whether a notification is sent to the at-home user may be based on the user-defined second-tier relationships. In some embodiments, while an authorized user may be used for the threshold distance determination, the notifications may be transmitted according to the defined relationships for the highest-ranked registered user at home.

At block 645, a determination may be made if a home automation notification is to be transmitted to another user. The home automation notification may be sent to another user, such as in accordance with relationships defined in relation to Table 2. The home automation notification indicative of the home automation event may be transmitted at block 650.

FIG. 7 illustrates an embodiment of a method 700 for configuring individual home automation sensor locations. Method 700 may be performed using various home automation sensor devices, a home automation host, such as home automation host 200, which can be incorporated as part of overlay device 140, television receiver 170, or some other form of home automation host system which can reside at a home or, possibly, remotely such as in the form of a cloud-based platform. Method 700 also uses a mobile device which has location-determining capabilities, such as GPS or some other location determination system. Method 700 may be particularly useful for home automation sensors that cannot determine their own locations.

At block 710, a home automation sensor may be registered with the home automation host. This can include configuring the home automation sensor and the home automation host to communicate with each other such that the home automation sensor can provide data to the home automation host that triggers home automation events. At block 720, the user may activate an application on his mobile device and provide input selecting the home automation sensor (e.g., from a retrieved list of home automation sensors from the home automation host). The user may, at block 730, hold his mobile device in the vicinity of the home automation sensor or in the area sensed by the home automation sensor (e.g., it might be more useful for the location of a central point of a camera's field of view to have its location logged than the home automation camera itself). At block 740, the mobile device may record its position in response to user input indicating that the mobile device is being held at the correct position.

At block 750, this detected location may be transmitted to the home automation host and linked with the home automation device. As such, for future home automation events originating from this home automation sensor at block 760, it may be assumed that the home automation event occurred at the location linked at block 750. As such, a distance relationship with any at-home user can be determined, such as in accordance with method 600.

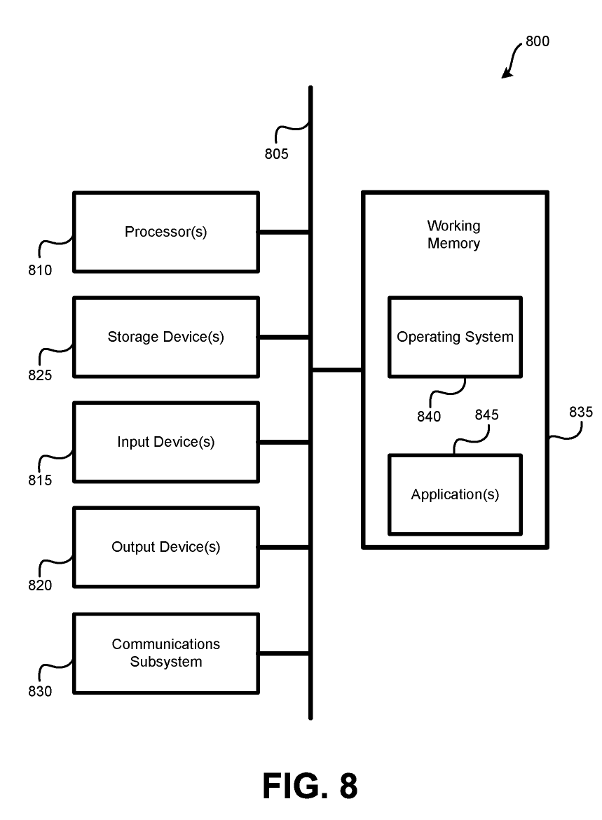

FIG. 8 illustrates a computer system 800 that can be incorporated as part of the home automation host, a cloud-based home automation system, and/or a mobile device as detailed in this document. FIG. 8 provides a schematic illustration of one embodiment of a computer system 800 that can perform various steps of the methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication). The hardware elements may include one or more processors 810, including without limitation one or more general-purpose processors and/or one or more special-purpose processors (such as digital signal processing chips, graphics acceleration processors, video decoders, and/or the like); one or more input devices 815, which can include without limitation a mouse, a touchscreen, keyboard, remote control, and/or the like; and one or more output devices 820, which can include without limitation a display device, a printer, etc.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a solid state drive (“SSD”), random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset (such as a Bluetooth™ device, BLE, an 802.11 device, an 802.15.4 device, a WiFi device, a WiMax device, cellular communication device, etc.), and/or the like. The communications subsystem 830 may permit data to be exchanged with a network (such as the network described below, to name one example), other computer systems, and/or any other devices described herein. In many embodiments, the computer system 800 will further comprise a working memory 835, which can include a RAM or ROM device, as described above.

The computer system 800 also can comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 800) to perform methods in accordance with various embodiments of the invention. According to a set of embodiments, some or all of the procedures of such methods are performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the non-transitory storage device(s) 825. Merely by way of example, execution of the sequences of instructions contained in the working memory 835 might cause the processor(s) 810 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 (and/or components thereof) generally will receive signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a non-transitory storage device 825 either before or after execution by the processor(s) 810.

It should further be understood that the components of computer system 800 can be distributed across a network. For example, some processing may be performed in one location using a first processor while other processing may be performed by another processor remote from the first processor. Other components of computer system 800 may be similarly distributed. As such, computer system 800 may be interpreted as a distributed computing system that performs processing in multiple locations. In some instances, computer system 800 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for handling a home automation notification, the method comprising:
determining, by a home automation host system, a home automation event has occurred based on wireless data received from a home automation device;
determining, by the home automation host system, an authorized user of a plurality of authorized users is present at a home at which the home automation host system is installed;
suppressing, by the home automation host system, transmission of the home automation notification indicative of the home automation event to at least a subset of the plurality of authorized users based on the at least one authorized user being determined to be present at the home; and
logging, by the home automation host system, the home automation event, such that an indication of the home automation event and a timestamp are stored locally by the home automation host system.

2. The method for handling the home automation notification of claim 1, further comprising:
storing, by the home automation host system, location information for each home automation device of a plurality of home automation devices, wherein:
the location information for each home automation device of the plurality of home automation devices indicates a specific location at the home at which the home automation device is installed; and
the home automation device is part of the plurality of home automation devices.

3. The method for handling the home automation notification of claim 2, further comprising:
determining, by the home automation host system, a distance between the authorized user and the home automation device at which the home automation event occurred;
comparing, by the home automation host system, a threshold distance with the distance between the authorized user and the home automation device at which the home automation event occurred, wherein suppressing transmission of the home automation notification indicative of the home automation event to at least the subset of the plurality of authorized users is further based on the distance between the authorized user and the home automation device at which the home automation event occurred being less than the threshold distance.

4. The method for handling the home automation notification of claim 3, further comprising:
transmitting, by the home automation host system, the home automation notification to the authorized user located at the home based on the distance between the authorized user and the home automation device at which the home automation event occurred being less than the threshold distance.

5. The method for handling the home automation notification of claim 1, wherein determining the authorized user is present at the home is performed based on facial recognition from a video feed captured by a home automation video device.

6. The method for handling home automation notifications of claim 1, further comprising:
analyzing a video feed captured by the home automation device to determine a pet triggered the home automation event, wherein the home automation event is a motion detection home automation event.

7. The method for handling the home automation notification of claim 6, further comprising:
in response to analyzing the video feed captured by the home automation device and determining the pet triggered the motion detection home automation event, ceasing recording the video feed.

8. The method for handling the home automation notification of claim 1, wherein determining the authorized user is present at the home is performed using a location of a mobile device linked with a user account of the authorized user.

9. The method for handling the home automation notification of claim 1, further comprising:
determining, by the home automation host system, less than a threshold amount of time has elapsed between the authorized user of the plurality of authorized users being present at the home at which the home automation host system is installed and the home automation event occurring.

10. A home automation system, the method comprising:
one or more home automation sensors; and
a home automation host system distinct from the one or more home automation sensors, comprising:
one or more processors; and
a memory communicatively coupled with and readable by the one or more processors and having stored therein processor-readable instructions which, when executed by the one or more processors, cause the one or more processors to:
determine a home automation event has occurred based on wireless data received from a home automation device;
determine an authorized user of a plurality of authorized users is present at a home at which the home automation host system is installed;
suppress transmission of a home automation notification indicative of the home automation event to at least a subset of the plurality of authorized users based on the at least one authorized user being determined to be present at the home; and
log the home automation event, such that an indication of the home automation event and a timestamp are stored locally by the home automation host system.

11. The home automation host system of claim 1, wherein the processor-readable instructions, when executed, further cause the one or more processors to:
cause location information to be stored for each home automation device of a plurality of home automation devices, wherein:
the location information for each home automation device of the plurality of home automation devices indicates a specific location at the home at which the home automation device is installed; and
the home automation device is part of the plurality of home automation devices.

12. The home automation host system of claim 11, wherein the processor-readable instructions, when executed, further cause the one or more processors to:
determine a distance between the authorized user and the home automation device at which the home automation event occurred; and
compare a threshold distance with the distance between the authorized user and the home automation device at which the home automation event occurred, wherein suppressing transmission of the home automation notification indicative of the home automation event to at least the subset of the plurality of authorized users is further based on the distance between the authorized user and the home automation device at which the home automation event occurred being less than the threshold distance.

13. The home automation host system of claim 12, wherein the processor-readable instructions, when executed, further cause the one or more processors to:
cause the home automation notification to be transmitted to the authorized user located at the home based on the distance between the authorized user and the home automation device at which the home automation event occurred being less than the threshold distance.

14. The home automation host system of claim 10, wherein determining the authorized user is present at the home is performed based on facial recognition from a video feed captured by a home automation video device.

15. The home automation host system of claim 10, wherein the processor-readable instructions, when executed, further cause the one or more processors to:
analyze a video feed captured by the home automation device to determine a pet triggered the home automation event, wherein the home automation event is a motion detection home automation event.

16. The home automation host system of claim 15, wherein the processor-readable instructions, when executed, further cause the one or more processors to:
cease recording the video feed in response to analyzing the video feed captured by the home automation device and determining the pet triggered the motion detection home automation event.

17. The home automation host system of claim 10, wherein determining the authorized user is present at the home is performed using a location of a mobile device linked with a user account of the authorized user.

18. The home automation host system of claim 10, wherein the processor-readable instructions, when executed, further cause the one or more processors to:
determine less than a threshold amount of time has elapsed between the authorized user of the plurality of authorized users being present at the home at which the home automation host system is installed and the home automation event occurring.

19. The home automation host system of claim 10, wherein the home automation host system further comprises:
a video input interface; and
a video output interface, wherein the home automation host system outputs home automation data in combination with vide received via the video input interface.

20. A non-transitory processor-readable medium for a home automation host system, the non-transitory processor-readable medium comprising processor-readable instructions that cause one or more processors to:
determine a home automation event has occurred based on wireless data received from a home automation device;
determine an authorized user of a plurality of authorized users is present at a home at which the home automation host system is installed;
suppress transmission of a home automation notification indicative of the home automation event to at least a subset of the plurality of authorized users based on the at least one authorized user being determined to be present at the home; and
log the home automation event, such that an indication of the home automation event and a timestamp are stored locally by the home automation host system.
